(19) United States
(12) Patent Application Publication
(10) Pub. No.: US 2009/0022349 A1
(43) Pub. Date: Jan. 22, 2009

(54) Configuration with a Wearing Hook for Hearing Devices and Associated Method

(75) Inventors: Wai Kit David Ho, Singapore (SG); Thomas Kasztelan, Berlin (DE); Wee Haw Koo, Singapore (SG); Beng Hai Tan, Singapore (SG)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/174,908

(22) Filed: Jul. 17, 2008

(30) Foreign Application Priority Data
Jul. 17, 2007 (DE) 10 2007 033 289.2

(51) Int. Cl. H04R 25/00

(52) U.S. Cl. 381/330

(57) ABSTRACT

A wearing hook for hearing devices has at least one device disposed in a sound channel of the wearing hook. The device is able to influence interfering sound-induced oscillations of the wearing hook. The device is for instance a tube made of metal. An associated method is likewise described for influencing the oscillations.

### CROSS-REFERENCE TO RELATED APPLICATION

This application claims the priority, under 35 U.S.C. § 119, of German application DE 10 2007 033 289.2, filed Jul. 17, 2007; the prior application is herewith incorporated by reference in its entirety.

### BACKGROUND OF THE INVENTION

### Field of the Invention

The invention relates to a wearing hook for a hearing device and a method for influencing oscillations in a wearing hook.

Hearing devices with a behind-the-ear part are generally equipped with a wearing hook to ensure that the behind-the-ear part rests comfortably and securely behind the ear of the hearing device wearer. Aside from the wearing function, the interior of the wearing hook, the so-called sound channel, routes the acoustic signal formed in a receiver of the behind-the-ear part to a sound tube connected to the wearing hook. This is connected to an ear mold.

Excitation using sound waves from an emitted acoustic signal nevertheless causes the wearing hook and/or device to vibrate in the audible frequency range into unwanted, interfering oscillations. These oscillations caused by resonance are received by a microphone in the hearing device and are amplified by an amplifier circuit of the hearing device. This result in unwanted sound couplings, particularly in the case of high amplifications, the sound couplings being superimposed on the acoustic useful signal in an interfering fashion.

The wearing hook can be configured to be rigid in order to prevent oscillations and interfering couplings. Rigid plastic wearing hooks can however break easily and are problematic to use in respect of their metallic connecting pieces. German utility model patent application DE 298 19415 U1 of the applicant describes various improved rigid wearing hook constructions, for instance with a plastic-metal composite.

### SUMMARY OF THE INVENTION

It is accordingly an object of the invention to provide a configuration with a wearing hook for hearing devices and an associated method which overcome the above-mentioned disadvantages of the prior art methods and devices of this general type, which is simply structured and does not produce any interfering sound couplings as a result of oscillations.

With the foregoing and other objects in view there is provided, in accordance with the invention, a wearing hook for a hearing device. The wearing hook includes a wearing hook body having a sound channel formed therein; and at least one device disposed in the sound channel and embodied such that oscillations of the wearing hook can be influenced.

This is advantageous in that oscillations of the wearing hook can be changed such that these can no longer be amplified in an interfering fashion for a hearing device wearer by the hearing device. As a result, hearing devices may have greater amplification reserves.

The oscillations can be influenced independently of the material properties and the shape of the wearing hook.

Manufacturing tolerances of the wearing hook no longer have an effect on the oscillation behavior of the wearing hook.

In additional embodiments, the amplitude and frequency of the oscillations of the wearing hook can be influenced by the spatial position of the device in the sound channel and/or by the shape of the device and/or by the weight of the device. As a result, a large amount of constructive play exists as do different possibilities for influencing the oscillations of the wearing hook.

The amplitude of the oscillations can be reduced and/or the frequency of the oscillations can be lowered.

It is advantageous here for the oscillations to be shifted to inaudible low frequencies and/or to be damped to such an extent that they can no longer be amplified to be audible.

In a further embodiment, the device includes a metallic tube disposed in the sound channel of the hearing device hook, the sound tube being operatively connected to the wearing hook.

As a result, the amplitude and frequency of the oscillation of the wearing hook can be influenced easily according to the position and length of the tube.

In another embodiment, the device includes one or several vibration damping weights.

As a result, the oscillation-influencing effect of the device can be easily controlled and/or adjusted.

An acoustic damping element can be disposed inside the device. This influences the propagation properties of the sound waves in the sound channel.

This is advantageous in that the sound frequency spectrum can thus be easily adjusted.

The wearing hook can be connected to a behind-the-ear part of the hearing device.

Furthermore, the invention specifies a method in which the device influencing the oscillations is moved into the sound channel of the wearing hook for the damping and frequency shift of sound-induced oscillations of a wearing hook.

Other features which are considered as characteristic for the invention are set forth in the appended claims.

Although the invention is illustrated and described herein as embodied in a configuration with a wearing hook for hearing devices and an associated method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a behind-the-ear part with a wearing hook according to the invention;

FIG. 2 is a diagrammatic, perspective view of a tube;

FIG. 3 is a diagrammatic, sectional view of the wearing hook with the tube;

FIG. 4 is a diagrammatic, perspective view of an acoustic damping element;

FIG. 5 is a diagrammatic, sectional view of the wearing hook with the tube and the acoustic damping element;

FIG. 6 is a diagrammatic, perspective view of a wearing hook damper;

FIG. 7 is a diagrammatic, perspective view of the wearing hook with the wearing hook damper; and

FIG. 8 is a flow chart.

### DETAILED DESCRIPTION OF THE INVENTION

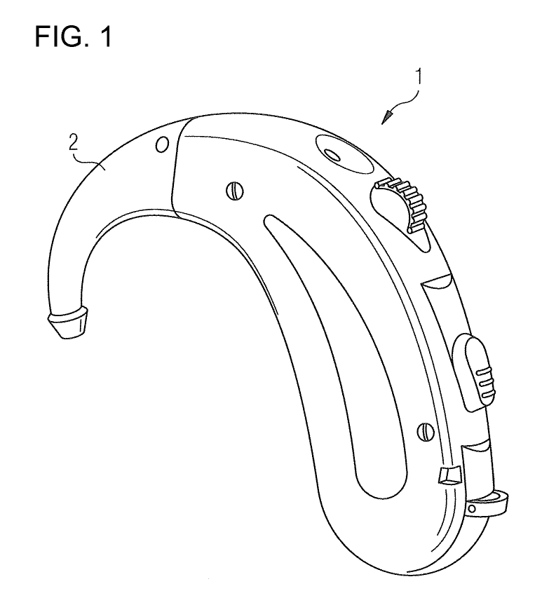

Referring now to the figures of the drawing in detail and first, particularly, to FIG. 1 thereof, there is shown a behind-the-ear part 1 of a hearing device. An inventive wearing hook 2 with an oscillation-influencing device 3, 5 (not visible) is fastened to the upper end of the behind-the-ear part 1. Acoustic signals are recorded using a microphone of the behind-the-ear part 1 and are supplied to an amplifier circuit as electric signals. After processing and amplifying the electric signals, the signals are converted back in a receiver into acoustic signals and are forwarded via a sound channel of the wearing hook 2.

A housing end of the hearing device formed by the wearing hook 2 has a truncated cone-shaped thickening at its end, via which a non-illustrated sound tube can be moved, which continues the sound channel to the auditory canal of the hearing device wearer.

Furthermore, a switch cover, below which a membrane key and a programmable socket are located, and a volume controller are visible.

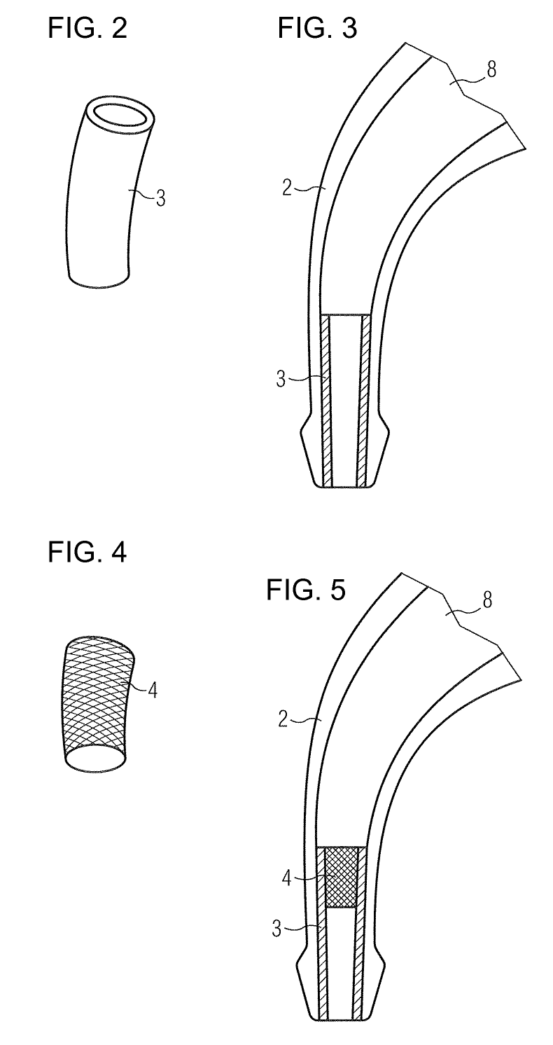

FIG. 2 shows a tube and/or damper 3 as the oscillation-influencing device. The tube 3 is formed of metal for instance, is approximately one third of the length of the wearing hook 2 and has an external diameter of approximately a diameter of a sound channel 8 of the wearing hook 2.

By changing the length and wall thickness of the tube 3, the weight and shape of the same can be changed, as a result of which the influence on natural oscillations of the wearing hook 2 can be changed by introducing the tube into the wearing hook 2. The choice of material also influences the weight.

FIG. 3 shows the tube 3 from FIG. 2 when introduced into the wearing hook 2. The wall thickness and length of the tube 3 are selected such that the sound transmission in the sound channel 8 of the wearing hook 2 is not disturbed and the sound-induced oscillations of the wearing hook are effectively damped and/or moved to lower, no longer audible frequencies. It suffices if only one part of the sound channel is lined with the tube 38.

The tube 3 fits firmly in the sound channel 8 but can however be removed and replaced by another tube 3 should the hearing device acoustician deem it necessary for instance.

By introducing the tube 3 into the wearing hook 2 after its manufacture, the suitable and effective oscillation-influencing tube 3 can be easily selected according to the shape and material of the wearing hook 2.

FIG. 4 shows an acoustic damping element 4, made of fine synthetic plastic for instance, which can be introduced into the tube 3 in FIG. 3. A different embodiment of the synthetic plastic allows the frequency response of the sound transmission in the sound channel 8 to be changed if necessary.

FIG. 5 shows the acoustic damping element 4 according to FIG. 4 together with the tube 3 according to FIG. 2 when introduced into the sound channel 8 of the wearing hook 2. This fits firmly in the tube and is fashioned to be non-slip.

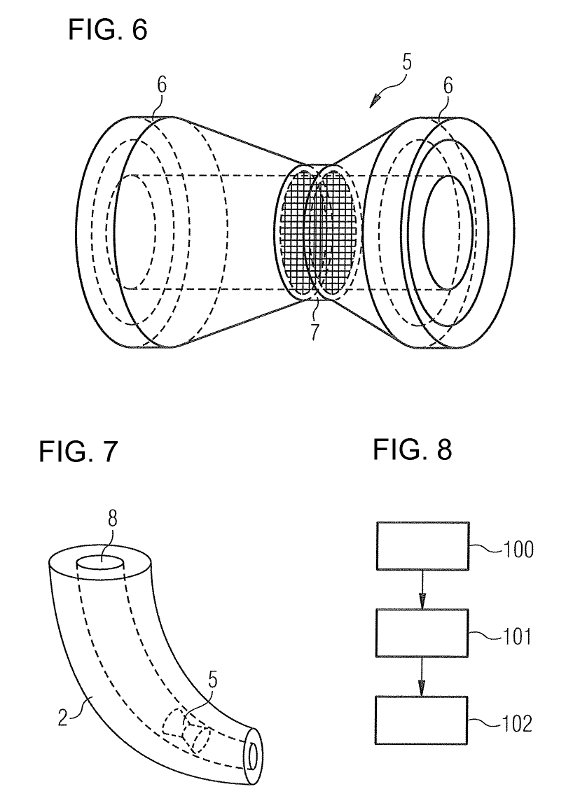

FIG. 6 shows an additional embodiment of the inventive device 5 in the form of a pipe having two vibration damping weights 6 made of metal and an acoustic damping element 7 attached to the two ends. The damping element 7 includes a fine, gauze-like synthetic plastic for instance. This combination is also referred to as a wearing hook damper. The vibration damping weights 6 can preferably be arranged symmetrically.

FIG. 7 shows the device 5 from FIG. 6 when introduced into the sound channel 8 of the wearing hook 2. For optimum efficiency, the device 5 is preferably disposed in the vicinity of the sound exit end of the wearing hook 2.

FIG. 8 reproduces the sequence of the inventive method. The wearing hook 2 is provided in step 100. In a subsequent step 101, the device 3, 5 that is suited to the wearing hook 2 is selected. In a final step 102, the device 3, 5 is introduced into the sound channel 8 of the wearing hook 2.

1. A wearing hook for a hearing device, the wearing hook comprising:
a wearing hook body having a sound channel formed therein; and
at least one device disposed in said sound channel and embodied such that oscillations of the wearing hook can be influenced.

2. The wearing hook according to claim 1, wherein an amplitude and frequency of the oscillations of the wearing hook can be influenced by a spatial position of said device in said sound channel.

3. The wearing hook according to claim 1, wherein an amplitude and frequency of the oscillations of the wearing hook can be influenced by a shape of said device.

4. The wearing hook according to claim 1, wherein an amplitude and frequency of the oscillations of the wearing hook can be influenced by a weight of said device.

5. The wearing hook according to claim 1, wherein at least one of an amplitude of the oscillations can be reduced and a frequency of the oscillations can be lowered.

6. The wearing hook according to claim 1, wherein said device includes a metallic tube disposed in said sound channel of said wearing hook body, said tube being operatively connected to said wearing hook body.

7. The wearing hook according to claim 1, wherein said device includes at least one vibration damping weight.

8. The wearing hook according to claim 1, further comprising an acoustic damping element disposed inside said device and embodied such that propagation properties of sound waves in said sound channel can be influenced.

9. A hearing device, comprising:
a wearing hook having a sound channel formed therein and at least one device disposed in said sound channel and embodied such that oscillations of said wearing hook can be influenced; and
a behind-the-ear part, said wearing hook being detachably connected to said behind-the-ear part.

10. A method for damping and shifting a frequency of sound-induced oscillations of a wearing hook of a hearing device, which comprises the step of:
disposing at least one device for influencing the sound-induced oscillations in a sound channel of the wearing hook.

11. A wearing hook for a hearing device, the wearing hook comprising:
a wearing hook body having a sound channel formed therein; and
at least one means disposed in said sound channel and embodied such that oscillations of the wearing hook can be influenced.

12. The wearing hook according to claim 11, wherein an amplitude and frequency of the oscillations of the wearing hook can be influenced by a spatial position of said means in said sound channel.

13. The wearing hook according to claim 11, wherein an amplitude and frequency of the oscillations of the wearing hook can be influenced by a shape of said means.

14. The wearing hook according to claim 11, wherein an amplitude and frequency of the oscillations of the wearing hook can be influenced by a weight of said means.

15. The wearing hook according to claim 11, wherein said device includes a metallic tube disposed in said sound channel of said wearing hook body, said tube being operatively connected to said wearing hook body.

16. The wearing hook according to claim 11, wherein said device includes at least one vibration damping weight.

17. The wearing hook according to claim 11, further comprising an acoustic damping element disposed inside said device and embodied such that propagation properties of sound waves in said sound channel can be influenced.
